(19) United States
(12) Patent Application Publication
(10) Pub. No.: US 2012/0309251 A1
(43) Pub. Date: Dec. 6, 2012

(54) Method for Retrofitting Flashlights And System Thereof

(76) Inventors: Sergei Yur'yevich Mironichev, Moscow (RU); Christopher D. Mechling, San Diego, CA (US)

(21) Appl. No.: 13/306,602

(22) Filed: Nov. 29, 2011

Related U.S. Application Data
(63) Continuation-in-part of application No. 13/009,143, filed on Jan. 19, 2011.
(60) Provisional application No. 61/296,235, filed on Jan. 19, 2010.

(51) Int. Cl. H01J 9/00

(52) U.S. Cl. 445/2

(57) ABSTRACT

A process and system for taking an ordinary existing flashlight and converting it to an advanced capability flashlight wherein the flashlight can be controlled remotely is disclosed herein. The system employs a relatively low cost method and takes advantage of modular characteristics of existing flashlights. The system additionally employs programmable electronics to the flashlight covered by a polyurethane protection layer to provide functionality in extreme conditions. Different head lamps can be easily switched out to an individual flashlight employing more LED lamps and different wavelengths of light as desired by a user. Additionally, a remote control device is disclosed, wherein the device can further be configured to a rail system of a firearm.

### PRIORITY CLAIM

This patent application contains subject matter claiming benefit of the priority date of U.S. patent application Ser No. 13/009,143 filed on Jan. 19, 2011, entitled SMART TACTICAL FLASHLIGHT AND SYSTEM THEREOF; U.S. Prov. Pat. App. Ser. No. 61/296,235 filed on Jan. 19, 2010 entitled SMART TACTICAL FLASHLIGHT; additionally this patent application contains subject matter claiming benefit of the priority date of U.S. patent application Ser. No. 12/537,111 filed on Aug. 6, 2009, entitled LIGHT CONTROL DEVICE which contains subject matter claiming benefit of international patent application No. PCT/RU2008/000508 filed on Aug. 7, 2008; additionally this patent application contains subject matter claiming benefit of the priority date of international patent application No. PCT/RU2009/000075, filed on Feb. 19, 2009 entitled SYSTEM FOR REMOTELY CONTROLLING SIGHTS AND TARGET DESIGNATORS, accordingly, the entire contents of these patent applications are hereby expressly incorporated by reference.

### BACKGROUND OF THE INVENTION

1. Field of the Invention

The present invention pertains generally to tactical illumination systems. More specifically, the present invention pertains to, hand held or mountable flashlights having more sophisticated electronics and other advanced capabilities for tactical environments also including wireless remote command and control In a preferred embodiment, the present invention relates to a method of retrofitting a flashlight to provide remote control capability and other advanced features.

2. Description of the Prior Art

Many nighttime operations, particularly those performed by military and law enforcement, depend on the latest advancements in illumination technology to attain the best possible advantage. Of specific interest, is the use of light weight, high intensity illumination systems in tactical environments. As such, a tactical user will desire either to mount a high intensity flashlight to a barrel of a weapon, or position the flashlight in relative proximity to the user.

There are many desirable features and specifications of these flashlights. One is that the flashlight can be controlled remotely instead of by wire or manually, particularly for military and covert applications where the light source does not reveal the user's location. Another desired feature is that the flashlight be easily convertible between white light, ultra-violet (UV) light, infrared (IR) light and/or various colored light. Also, a need exists to be able to retrofit an existing flashlight to provide advanced capabilities.

In light of the above, it is an object of the present invention to provide the desired method of retrofitting of an existing flashlight. It is still further an object of the present invention to provide a wireless design that is resistant to jamming and RF interference. An additional object of the present invention is to provide a tactical flashlight that is able to transmit a secure rescuer beacon. It is yet further an object of the present invention to provide a flashlight having a wireless strobe command and brightness control. It is yet still further an object of the present invention to provide a flashlight with programmable electronics and a motion sensor so that the flashlight and/or beacon can be programmed to turn off/on depending on physical movement thereof.

### BRIEF SUMMARY OF THE INVENTION

The present invention specifically addresses and alleviates the above mentioned deficiencies associated with the prior art. More particularly, the present invention in a first aspect, is a method for retrofitting an existing flashlight to provide remote control, and other advanced capabilities, the method comprising: providing a flashlight to be retrofitted, the flashlight having a first head lamp portion, a tubular body, and an end cap portion; replacing the first head lamp portion with a second head lamp portion; providing programmable electronics to the second head lamp portion; providing a remote controller device; and controlling remotely the existing flashlight with the remote controller via the second head lamp portion, wherein the first head lamp portion provided no such remote control capability.

The method for retrofitting an existing flashlight to provide remote control, and other advanced capabilities is additionally characterized wherein the controlling remotely comprises ON/OFF and brightness control. Also, the first preferred method comprises the step of employing a phase shift keying system for individual electronic addressing of a multitude of flashlights thereby also providing resistance to the electronic interference and jamming. Further the method includes covering the programmable electronics with a polyurethane protection layer. The invention herein further contemplates providing modularity with regard to the head lamp portion, the modularity comprising: a plurality of colors; an IR illumination headlamp; and a UV type illumination headlamp.

The method in this first aspect herein is additionally characterized as comprising the step of providing a three-axis gyroscope to the programmable electronics; activating or deactivating the flashlight depending on an orientation of the flashlight as sensed by the gyroscope. Also included is the step of encasing the remote controller device in shrink wrap plastic. Still further, the method herein comprises the steps of providing a radio beacon to the programmable electronics; and activating the radio beacon remotely or programmably to provide a signal to assist in locating the flashlight.

In yet a second aspect, the invention is a method of retrofitting an existing flashlight to provide remote control, and other advanced capabilities similar to that in the first aspect, except however a smart end cap portions provides the advanced capabilities. More specifically the method in the aspect comprises the steps of providing a flashlight to be retrofitted, the flashlight having a head lamp portion a tubular body, and a first end cap portion; replacing the first end cap portion with a second end cap portion; providing programmable electronics to the second end cap portion; providing a remote controller device; and controlling remotely the existing flashlight with the remote controller via the second end cap, wherein the first end cap provided no such remote control capability.

These, as well as other advantages of the present invention will be more apparent from the following description and drawings. It is understood that changes in the specific structure shown and described may be made within the scope of the claims, without departing from the spirit of the invention.

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112. The invention can be better visualized by turning now to the following drawings wherein like elements are referenced by like numerals.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1A together with FIG. 1B illustrate a system and method of retrofitting a flashlight with remote control capability according to the present invention;

FIG. 2 is an additional exploded perspective view further exemplifying a system and method of retrofitting a flashlight;

FIG. 3 is still an additional exploded perspective view of programmable electronics of the present invention; and

FIG. 4 is a perspective illustration of an intended use of the present invention.

### DETAILED DESCRIPTION OF THE PREFERRED EMBODIMENTS

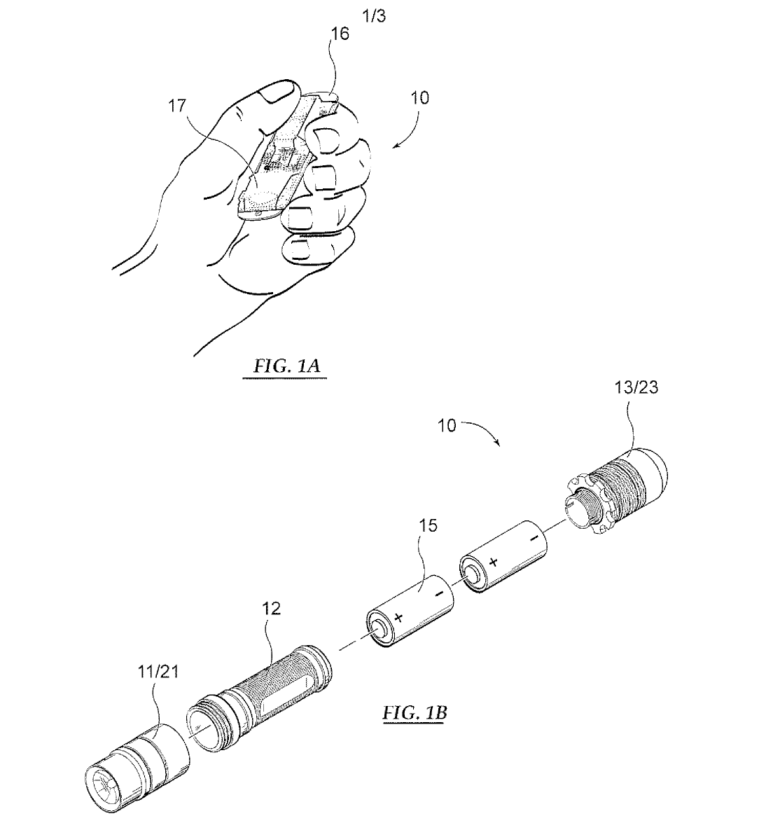

Initially, with regard to FIG. 1A and FIG. 1B, a preferred system 10 of the present invention is illustrated in perspective wherein either an end cap portion 13 or a head lamp portion 11 is retrofitted with a corresponding component with programmable electronics 21, 23. The flashlight system 10 providing remote control capability has been specifically envisioned for tactical situations to include military and law enforcement as well as recreational game hunting.

in a preferred embodiment shown in FIG. 1A, a remote control device 16 is provided that includes two buttons in the preferred embodiment. With regard to FIG. 1B, an existing flashlight 10 is provided according to the invention having a first head lamp portion 11, a tubular body 12, and an end cap portion 13. Then subsequently, as advanced capabilities are desired and as an alternative to providing a new flashlight with these features, the flashlight is instead retrofitted by only swapping out the first head lamp portion 11 with a second head lamp portion 21 with threads to match the first head lamp portion 11. Alternatively as also shown in FIG. 1A and FIG. 1B, the invention is a method of retrofitting an existing flashlight to provide remote control, and other advanced capabilities similar to that in the first aspect, except however a smart end cap portion 23 provides the remote and advanced capabilities. That is the first end cap portion 13 is swapped out with the second end cap portion 23 as well as other method steps as described herein. Also with regard to FIG. 1B, the remote controller device 16 is encased in shrink wrap plastic 17 for protection and durability in harsh environments.

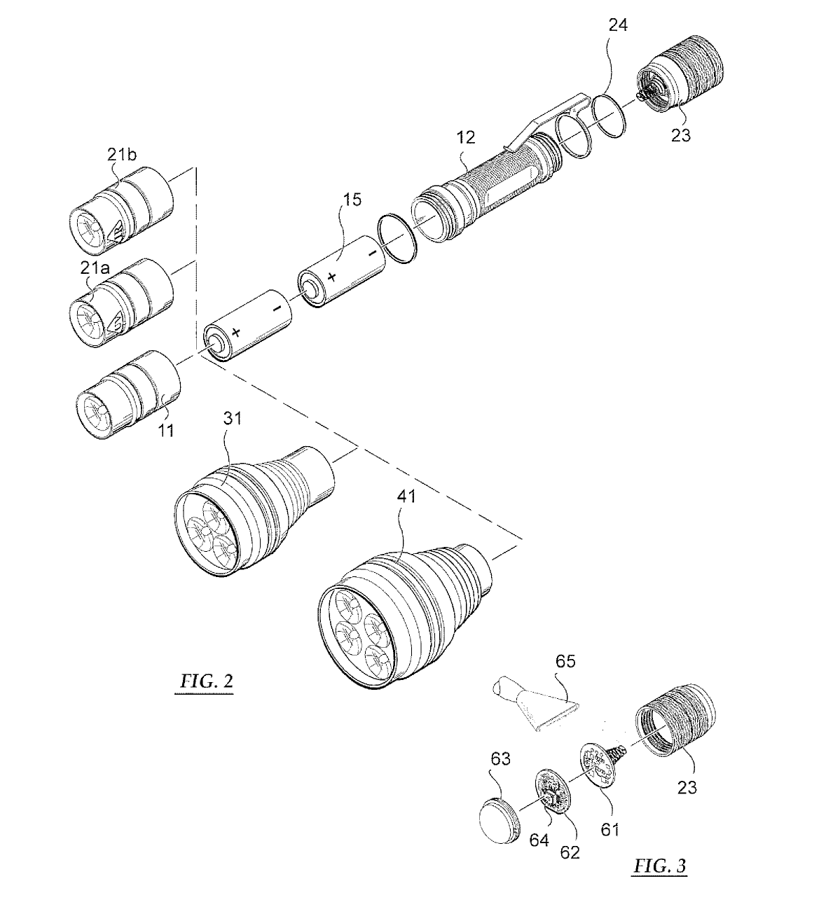

With reference to FIG. 2, the invention in a preferred embodiment is a method for retrofitting an existing flashlight 10 to provide remote control 16, and other advanced capabilities, the method initially comprising providing a flashlight 10 to be retrofitted wherein the flashlight has a first head lamp portion 11, a tubular body 12 housing batteries 15, and an end cap portion 13. Next the method provides for replacing the first head lamp portion 11 with a second head lamp portion 21, 21a, 21b, 31, 41; providing programmable electronics 61, 62 to the second head lamp portion 21; providing a remote controller device 16; and controlling remotely the existing flashlight 10 with the remote controller 16 via the second head lamp portion 21, wherein the first head lamp portion 11 provided no such remote control capability.

The invention herein further contemplates providing modularity with regard to the second head lamp portion 21, the modularity comprising: a plurality of colors; a UV type illumination headlamp 21a and IR illumination headlamp 21b. Additionally, greater intensity head lamps 31, 41 could also be configured to the flashlight adding to its modularity. Spacers 24 are provided between threads to allow for extra torque to components 21, 12, 23 further aiding a water tight design.

The method herein also provides a three-axis gyroscope configured to the programmable electronics 61. An activating or a deactivating of the flashlight 10 is then optionally based on an orientation of the flashlight 10 as sensed by the gyroscope. A radio beacon is additionally provided to the programmable electronics 61; and an activating the radio beacon remotely or programmably to provide a signal to assist in locating the flashlight 10 is further optionally provided by the present invention.

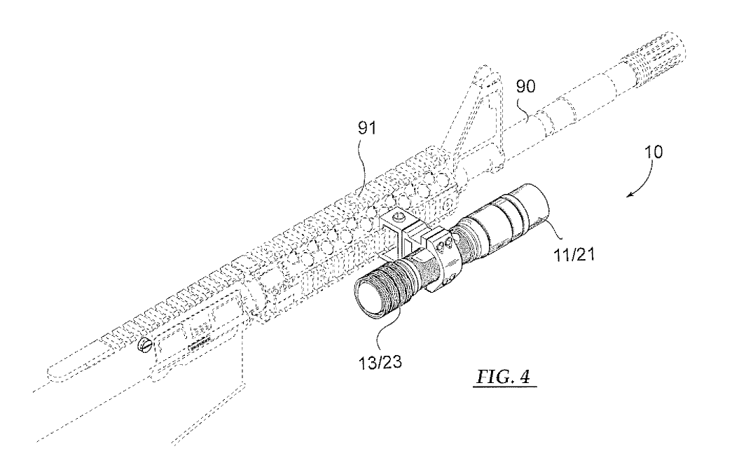

With reference to FIG. 3, the method for retrofitting an existing flashlight 10 to provide remote control 16 is additionally characterized as including covering the programmable electronics 61, 62 with a polyurethane protection layer 65. Also as shown, a local control button 64 is provided to the electronics 62. The end cap portion 23 further has a cover 63 to the control button.

More particularly to the remote control device 16, first remote control button serves to activate or deactivate the flashlight 10; while a second remote control button selects a flashlight mode and brightness. The flashlight 10 mode is changed from a steady beam to a strobe by momentarily clicking the second remote control button. Additionally, a flashlight 10 brightness is adjusted by pressing and holding the second remote control button. The brightness will cycle from low to high and back to low again to decrease brightness. Alternatively to remote operation, end cap button 64 is provided for manual operation. Also in a preferred embodiment, press and hold end cap button 64 until the flashlight 10 blinks once to activate the remote control; and press and hold the end cap until the flashlight blinks twice to deactivate the remote control 20, 20b, 30. The push button 64 manual control provided is preferable to twist on/off as used in other designs.

FIG. 4 illustrates an intended use of the present invention. Therein, a flashlight 10 is coupled to rifle barrel 90 via a rail mount system 91.

Many alterations and modifications may be made by those having ordinary skill in the art without departing from the spirit and scope of the invention. Therefore, it must be understood that the illustrated embodiments have been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations.

While the particular Smart Tactical Flashlight and System Thereof as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

What is claimed is:

1. A method for retrofitting an existing flashlight to provide remote control, and other advanced capabilities, the method comprising:
providing a flashlight to be retrofitted, the flashlight having a first head lamp portion a tubular body and an end cap portion;
replacing the first head lamp portion with a second head lamp portion;
providing programmable electronics to the second head lamp portion;
providing a remote controller device; and
controlling remotely the existing flashlight with the remote controller via the second head lamp portion, wherein the first head lamp portion provided no such remote control capability.

2. The method for retrofitting an existing flashlight to provide remote control, and other advanced capabilities of claim 1, wherein the controlling remotely comprises ON/OFF and brightness control.

3. The method for retrofitting an existing flashlight to provide remote control, and other advanced capabilities of claim 1, the method further comprising employing a phase shift keying system for individual electronic addressing of a multitude of flashlights thereby also providing resistance to the electronic interference and jamming.

4. The method for retrofitting an existing flashlight to provide remote control, and other advanced capabilities of claim 1, the method further comprising covering the programmable electronics with a polyurethane protection layer.

5. The method for retrofitting an existing flashlight to provide remote control, and other advanced capabilities of claim 1 further comprising providing modularity with regard to the head lamp portion, the modularity comprising:
a plurality of colors;
an IR illumination headlamp; and
a UV type illumination headlamp.

6. The method for retrofitting an existing flashlight to provide remote control, and other advanced capabilities of claim 1 further comprising:
providing a three-axis gyroscope to the programmable electronics; and
activating or deactivating the flashlight based on an orientation of the flashlight as sensed by the gyroscope.

7. The method for retrofitting an existing flashlight to provide remote control, and other advanced capabilities of claim 1 further comprising encasing the remote controller device in shrink wrap plastic.

8. The method for retrofitting an existing flashlight to provide remote control, and other advanced capabilities of claim 1 further comprising:
providing a radio beacon to the programmable electronics; and
activating the radio beacon remotely or programmably to provide a signal to assist in locating the flashlight.

9. A method for retrofitting an existing flashlight to provide remote control, and other advanced capabilities, the method comprising:
providing a flashlight to be retrofitted, the flashlight having a head lamp portion a tubular body, and a first end cap portion;
replacing the first end cap portion with a second end cap portion;
providing programmable electronics to the second end cap portion;
providing a remote controller device;
and
controlling remotely the existing flashlight with the remote controller via the second end cap, wherein the first end cap provided no such remote control capability.

10. The method for retrofitting an existing flashlight to provide remote control, and other advanced capabilities of claim 9, wherein the controlling remotely comprises ON/OFF and brightness control.

11. The method for retrofitting an existing flashlight to provide remote control, and other advanced capabilities of claim 9, the method further comprising employing a phase shift keying system for individual electronic addressing of a multitude of flashlights thereby also providing resistance to the electronic interference and jamming.

12. The method for retrofitting an existing flashlight to provide remote control, and other advanced capabilities of claim 9, the method further comprising covering the programmable electronics with a polyurethane protection layer.

13. The method for retrofitting an existing flashlight to provide remote control, and other advanced capabilities of claim 9 further comprising providing modularity with regard to the head lamp portion, the modularity comprising:
a plurality of colors;
an IR illumination headlamp; and
a UV type illumination headlamp.

14. The method for retrofitting an existing flashlight to provide remote control, and other advanced capabilities of claim 1 further comprising:
providing a three-axis gyroscope to the programmable electronics; and
activating or deactivating the flashlight depending on an orientation of the flashlight as sensed by the gyroscope.

15. The method for retrofitting an existing flashlight to provide remote control, and other advanced capabilities of claim 9 further comprising encasing the remote controller device in shrink wrap plastic.

16. The method for retrofitting an existing flashlight to provide remote control, and other advanced capabilities of claim 1 further comprising:
providing a radio beacon to the progamable electronics; and
activating the radio beacon remotely or programmably to provide a signal to assist in locating the flashlight.
